(19) United States
(12) Patent Application Publication
(10) Pub. No.: US 2014/0295851 A1
(43) Pub. Date: Oct. 2, 2014

(54) Methods, Apparatus and Computer Programs for Operating a User Equipment

(71) Applicant: BROADCOM CORPORATION, Irvine, CA (US)

(72) Inventors: Keiichi KUBOTA, Weybridge (GB); Brian MARTIN, Farnham (GB)

(73) Assignee: BROADCOM CORPORATION, Irvine, CA (US)

(21) Appl. No.: 14/226,047

(22) Filed: Mar. 26, 2014

(30) Foreign Application Priority Data
Mar. 28, 2013 (GB) 1305740.1

(51) Int. Cl. H04W 36/34; H04W 36/00; H04W 36/32

(52) U.S. Cl. CPC H04W 36/34; H04W 36/32; H04W 36/0055
USPC 455/441; 455/436

(57) ABSTRACT

In a first embodiment a user equipment (UE) applies a temporary offset to a cell selection and/or a cell re-selection criterion or criteria in response to determining that a condition is satisfied for the UE. Thereafter, the cell is evaluated for selection or re-selection according to the respective cell selection or cell re-selection criterion or criteria with the applied offset. In a second embodiment, a restriction is imposed for evaluating a cell for selection or re-selection in response to determining that a condition is satisfied for the UE; and the restriction is removed in response to determining that the UE is non-stationary. Examples for the condition include the UE speed being less than a threshold, an indication of the offset being in system information, or a failed number of consecutive random access attempts. Examples of the restriction are the first embodiment's offset and barring the cell for selection/re-selection purposes.

### TECHNICAL FIELD

The present invention relates to methods, apparatus and computer programs for operating a user equipment. The exemplary and non-limiting embodiments of this invention relate generally to wireless communication systems, methods, devices and computer programs and specific embodiments relate to cell reselection in a radio network by a user equipment (UE).

### BACKGROUND

A problem in wireless networks has been identified in which a stationary user equipment (UE) attempts to camp on a cell for which it cannot establish a connection. This problem is known in the art as the Chiba issue, as it was brought to light in view of UEs receiving a stronger signal from a Node B located across Tokyo bay in Japan's Chiba prefecture than the signal it receives from a NodeB located in the UE's own Kanagawa prefecture, as shown in FIG. 1. In this problematic network deployment scenario, cells located on either side of a lake can cause some UEs to attempt to camp on the cell on the wrong side of the lake which can result in the UE being unable to successfully transmit a random access request on the uplink random access channel (RACH) to the network.

Document R2-130436 by NTT DOCOMO, Inc. entitled RACH transmission Failure issue (3GPP TSG-RAN WG2 Meeting #81; St. Julian, Malta; 28 Jan. to 1 Feb. 2013) sets forth further detail on the Chiba issue with respect to FIG. 2 as follows. A static UE such as a vending machine or smart meter is located in cell A of location area A and is nearer to NodeB_A, but camps on NodeB_B which controls cell B within location area B (step 1 of FIG. 2). Cell B_B is the wrong cell. This stronger signal strength from the further cell may arise due to higher measured power in the downlink which results from a reflected wave on the standing water between the further Node B_B and the UE. But the UE's uplink RACH transmission (step 2 of FIG. 2) does not reach NodeB_B and as a result the UE is unable to register on the network with NodeB_B (step 3 of FIG. 2), due to attempting to camp on the wrong cell. The UE remains on the wrong cell due to the reselection criteria being met for the wrong cell (step 4 of FIG. 2), but absent some change in the reflected wave the UE will continue to see a stronger signal from NodeB_B and so it will continue to meet the reselection criteria.

Document R2-130436 also details that it is difficult to address this by changing the existing reselection parameters that are broadcast by the network, because this change would affect UEs which should be served by the cell in location area B, and also UEs which are moving from location area A to location area B (for example on a boat in Tokyo Bay).

A different solution is proposed in a change request to 3GPP TS 25.331 by NTT DOCOMO, Inc. at document R2-130440 entitled Handling of the current cell when the UE failed in RRC connection establishment (3GPP TSG-RAN WG2 Meeting #81; St. Julian, Malta; 28 Jan. to 1 Feb. 2013). This proposed change to TS25.311 would have the UE bar the cell when the UE fails to complete a primary RACH (PRACH) preamble transmission after reaching its maximum allowed number of PRACH re-transmissions. The inventors consider that this proposed solution would result in UEs incorrectly barring cells in deployments of cells other than the Tokyo Bay-type deployment, which would lead to different UEs camping on the wrong cell if they had barred the correct cell for the wrong reason. A different solution is set forth below.

### BRIEF DESCRIPTION OF THE DRAWINGS

FIG. 1 is a prior art overview of a region around Tokyo Bay in which non-mobile UEs can attempt to camp on a cell to which they cannot connect, and represents schematically one problem that embodiments of these teachings resolve;

FIG. 2 is a prior art schematic diagram illustrating signalling which a stationary UE undergoes when operating in the region shown at FIG. 1;

FIG. 3 is an example of a table that includes a new information element which the network can signal the UE for indicating a value of an offset to be used in a cell according to a first embodiment of these teachings;

FIGS. 4 and 5 are logic flow diagrams that each illustrate examples of the operation of a method, a result of execution of by apparatus, and execution of computer instructions comprising code embodied on a computer-readable memory, in accordance with the exemplary embodiments of this invention; and

FIG. 6 is a simplified block diagram of an example of a UE in communication with an Access Node and a UTRAN RNC illustrating exemplary electronic devices suitable for use in practicing the exemplary embodiments of this invention.

### DETAILED DESCRIPTION

The examples detailed herein are in the context of a UE operating in a radio network utilizing the Universal Terrestrial Radio Access (UTRA) radio access technology, but this is only one example in order to provide a practical context for describing the inventive concepts detailed herein. These teachings may be utilized with other types of radio access technologies, such as for example Evolved UTRAN (E-UTRAN, sometime referred to as Long Term Evolution or LTE and including LTE-Advanced), Global System for Mobile Communications (GSM), Wideband Code Division Multiple Access (WCDMA) and the like. The specific names of messages and of various network entities in the examples below follow the nomenclature for UTRA networks (UTRANs) and these names also are not limiting to the broader teachings presented below but are for clarity of explanation.

According to a first aspect of the present invention, there is provided a method for operating a user equipment (UE), the method comprising: applying a temporary offset to a cell selection and/or a cell re-selection criterion or criteria in response to determining that a condition is satisfied for a user equipment (UE); and thereafter evaluating the cell for selection or re-selection according to the respective cell selection or cell re-selection criterion or criteria with the applied offset.

According to a second aspect of the present invention, there is provided apparatus for operating a user equipment (UE), the apparatus comprising a processing system configured to cause the apparatus at least to: apply a temporary offset to a cell selection and/or a cell re-selection criterion or criteria in response to determining that a condition is satisfied for a user equipment (UE); and thereafter evaluate the cell for selection or re-selection according to the respective cell selection or cell re-selection criterion or criteria with the applied offset.

According to a third aspect of the present invention, there is provided a computer program comprising a set of computer instructions comprising: code for applying a temporary offset to a cell selection and/or a cell re-selection criterion or criteria in response to determining that a condition is satisfied for a user equipment (UE); and code for thereafter evaluating the cell for selection or re-selection according to the respective cell selection or cell re-selection criterion or criteria with the applied offset.

According to a fourth aspect of the present invention, there is provided a method for operating a user equipment (UE), the method comprising: imposing a restriction for evaluating a cell for selection or re-selection in response to determining that a condition is satisfied for a user equipment (UE); and removing the restriction in response to determining that the UE is non-stationary.

According to a fifth aspect of the present invention, there is provided apparatus for operating a user equipment (UE), the apparatus comprising a processing system configured to cause the apparatus at least to: impose a restriction for evaluating a cell for selection or re-selection in response to determining that a condition is satisfied for a user equipment (UE); and remove the restriction in response to determining that the UE is non-stationary.

According to a sixth aspect of the present invention, there is provided a computer program comprising a set of computer instructions comprising: code for imposing a restriction for evaluating a cell for selection or re-selection in response to determining that a condition is satisfied for a user equipment (UE); and code for removing the restriction in response to determining that the UE is non-stationary.

The processing systems described above may comprise at least one processor and at least one memory including computer program code.

There may be provided a computer readable memory tangibly storing a set of computer instructions as described above.

Further features and advantages of the invention will become apparent from the following description of preferred embodiments of the invention, given by way of example only, which is made with reference to the accompanying drawings.

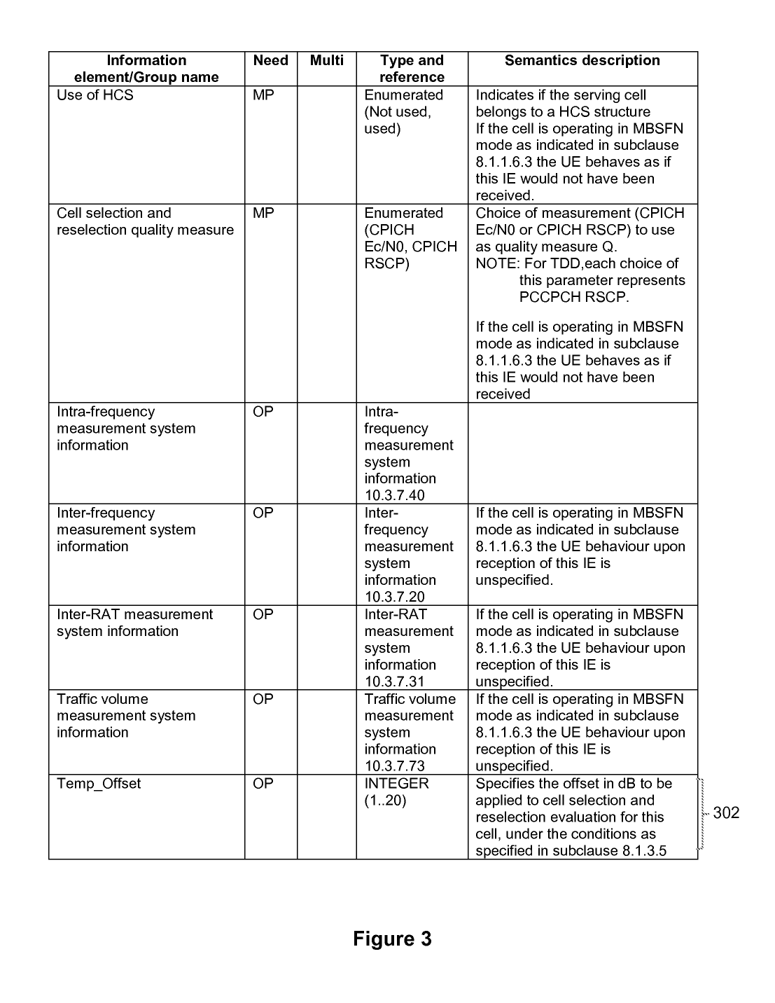

In accordance with a first embodiment of the invention, the UE applies an offset to the cell when performing cell selection/reselection evaluation. With reference to FIG. 2, the UE would be applying this offset when evaluating cell B (NodeB_B) for selection/reselection. To avoid the potential problem noted above for document R2-130440 in which the wrong cell could be barred, this offset is selectively applied based on the UE meeting a condition. Examples of such an offset are presented below following some example conditions to satisfy before applying the offset itself.

In one implementation the condition for applying the offset is the UE detecting the Chiba-type failure condition based on a predetermined number of failed PRACH attempts. In other embodiments some other failure condition can be used as this condition to apply the offset.

In another implementation the offset can be applied only when the UE has received system information, from the cell to which the offset would be applied in the selection/reselection evaluation (cell B in FIG. 2), that indicates the offset should be used. In one example of this second implementation, the cell has as little as a single bit (one flag) in system information which indicates to the UE that a predetermined offset should be used. Such a predetermined offset may be known to the NodeB and the UE from being in a published standard such as 3GPP TS25.304. In a different example of this second implementation, the cell broadcasts a value for the offset which the UE receives and applies for its selection/reselection evaluation of that cell.

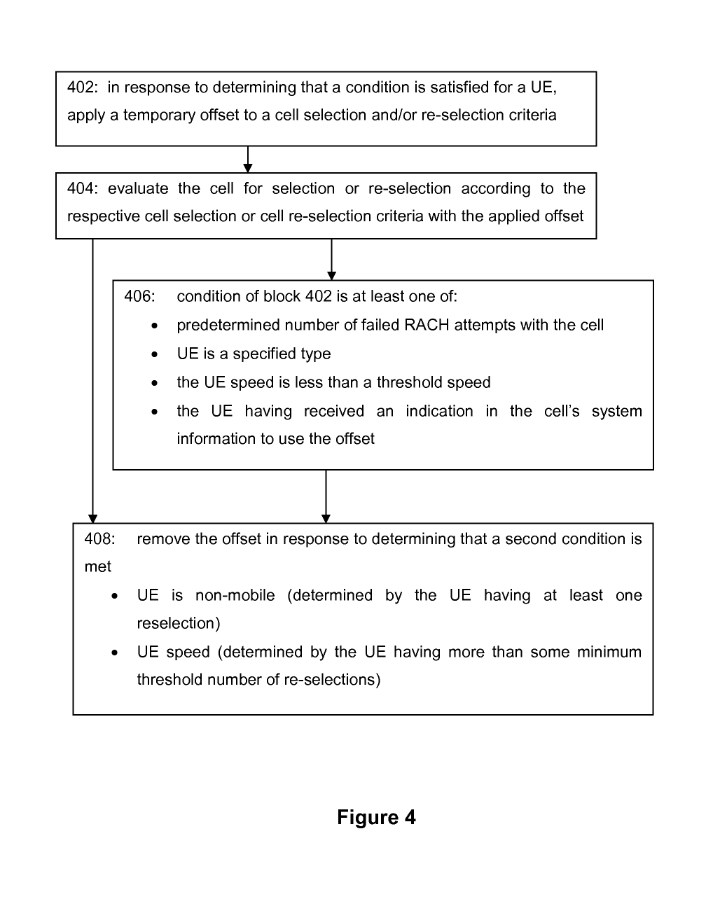

As a non-limiting example, a new information element (IE) can be added to the UTRAN cell's broadcast system information block 11 (SIB11), or SIB11bis, or SIB12 to carry this offset information. For the case of the system information having a single bit/flag, the flag would indicate to the UE to apply the offset. For the case of the system information having the offset value, the new IE in the SIB would indicate that offset value. FIG. 3 shows an example of such a new IE at 302, named Temp_Offset which specifies the offset in dB to be applied to sell selection and reselection evaluation for the cell that sends it, where the offset is applied if conditions specified elsewhere are satisfied. For EUTRAN it would be advantageous to add such a new IE to the cell's SIB3 broadcast.

In still another implementation of this first embodiment, the condition is that the UE is of a specific type, for example a machine-type communication (MTC) device that is immobile such as a smart meter or a vending machine MTC device. In this case, UEs of that type know to always apply the offset, of the relevant cell may broadcast in system information which types of UEs are to apply the offset, or the relevant cell may broadcast the indication of the offset or its actual value and only UEs of the type specified in published radio standards know they are to apply that offset. The device type may be a property configured in the device by the operator or may correspond to a subscription type as two non-limiting examples of UE type.

In a further implementation of this first embodiment, the condition is that the speed of the UE is below a threshold speed. This threshold speed may be set to be slightly above zero to capture only stationary UEs that can meet this condition, or it may be set higher to capture also slow moving UEs as having this condition.

Especially considering that some UEs which these teachings seek to use the offset may be low-cost machine-type communication (MTC) devices in a UTRAN or EUTRAN system which are not likely to have the appropriate hardware/software to detect their own speed directly, any given UE can use a proxy for its own speed to see if this condition is fulfilled. For example, the speed condition may be fulfilled if the UE detects that it has counted zero reselections over a fixed period of time. In that case such a UE would detect that it is stationary and know that it is to apply the offset, which makes this UE camping on the current cell more stable since it will not reselect until later when it moves (if at all). This can prevent unnecessary reselection in the stationary UE case. This is a slightly different use of the offset, because the bias imposed by the offset makes the stationary UE stay on the cell rather than cause the signal strength of the “wrong” cell to be weaker from the perspective of the UE's reselection evaluation.

For the case where the condition is also to capture slow moving UEs, which is more generic for a heterogeneous scenario such as may arise in UTRAN and EUTRAN, the offset would be applied upon detection of a slow speed for which the proxy can be fewer than X reselections over fixed time period, where X is some predetermined integer number. This implementation also enables small cell specific parameters to be used to bias the slower moving UEs towards camping on the small/pico cell.

Any of the above implementations for the condition: number of failed PRACH attempts; presence of the offset indication/value in system information; UE type; and UE speed below a threshold; can be used alone or two or more of them may be used in any given deployment of these teachings.

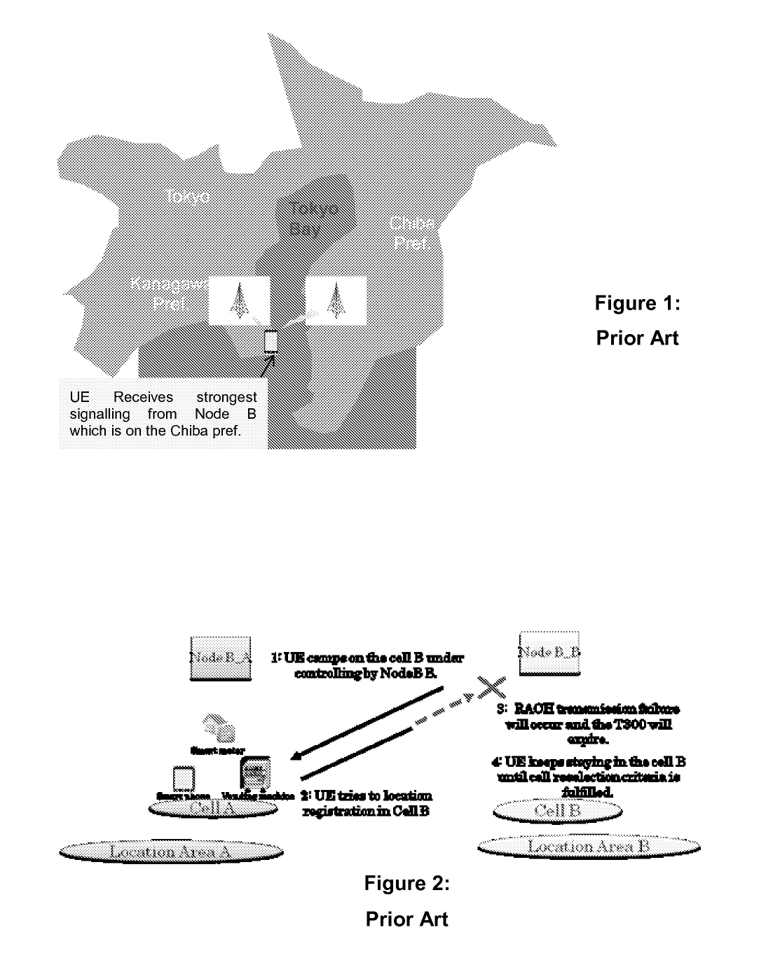

The following examples of the offset itself are specific to UTRAN and with reference to the Chiba issue detailed in the background and at FIGS. 1 and 2. As such, examples are given for both cell selection and cell reselection. For cell selection the offset examples include offsets to both signal quality (Squal) and signal level (Srxlev) since both are parameters which should be satisfied in UTRAN for a cell to meet selection criteria in UTRA. For cell re-selection, the offset examples include offsets to the inter-frequency ranking of the serving cell Rs and of the neighbor cell Rn, for similar reasons. The skilled artisan will see that these offset examples are readily adaptable to the EUTRAN system and also to other radio access technologies, and particularly heterogeneous network deployments of macro and small cells regardless of the radio access technology they use. In other deployments apart from UTRANs and EUTRANs, the offset may be for a single selection/reselection parameter (signal quality or level, serving or neighbor cell ranking), or for multiple mandatory selection/reselection parameters.

In the UTRA system, the cell selection criteria is met when the signal level Srxlev>0 and when the received signal quality Squal>0; where:

Squal=Q_{qualmeas}−(Qqualmin+QqualminOffset)

Srxlev=Qᵣₓₗₑᵥₘₑₐₛ−(Qrxlevmin+QrxlevminOffset)−Pcompensation

In the above, Q_{qualmeas} and Qᵣₓₗₑᵥₘₑₐₛ are the respective signal quality and level of the cell as measured by the UE; other variables are set by the network or by a published standard. The parameters QqualminOffset and QrxlevminOffset are not conditionally applied as is the offset according to these teachings. To avoid confusion, hereinafter the offset applied according to these teachings is referred to as a temporary offset, designated in the various formulas below as Temp_offset.

One way to implement these teachings for cell selection in UTRA is to modify the cell selection criteria in 3GPP TS 25.304 to include an additional offset Temp_offset as in the equations immediately below. An equivalent implementation is to increase the value of Qqualminoffset temporarily.

Squal=Q_{qualmeas}−(Qqualmin+QqualminOffset+Temp_offset)

Srxlev=Qᵣₓₗₑᵥₘₑₐₛ−(Qrxlevmin+QrxlevminOffset+Temp_offset)−Pcompensation

These teachings can be implemented for EUTRA systems using similar modifications for cell selection criteria specified at 3GPP TS36.304.

Cell re-selection criteria is performed in different ways. However, intra-frequency ranking is defined in UTRA as follows:

(serving cell) Rs=Qmeas,s+Qhysts+Qoffmbms

(neighbor cell) Rn=Qmeas,n−Qoffsets,n [symbol] +Qoffmbms−TOn*(1−Ln)

For cell re-selection in UTRA the UE selects the cell with the highest value of R. One way to implement these teachings for cell re-selection in UTRA is to apply a temporary offset to the particular cell when the problem is detected by the UE and/or when indicated by the network, which is then applied in this example by modifying 3GPP TS25.304 as follows:

(serving cell) Rs=Qmeas,s+Qhysts+Qoffmbms−Temp_offset

(neighbor cell) Rn=Qmeas,n−Qoffsets,n [symbol] +Qoffmbms−Temp_offset−TOn*(1−Ln)

If for example the condition to be satisfied is the cell indicating in system information that the offset is to be applied, then assuming the UE's serving cell but not the neighbor cell broadcast the offset indication it follows that the UE would use the Rs immediately above and the conventional Rn without the offset (or equivalently the Rn immediately above with an offset of zero since the neighbor cell did not broadcast one). To use these teachings to resolve the actual Chiba issue shown at FIG. 1 (assuming the UE is camped initially on cell A), only the neighbor cell B would be broadcasting the offset indication and the UE would use the Rn immediately above for cell B and use the conventional Rs without the offset for cell A (or equivalently the Rs immediately above with an offset of zero). If instead the condition is that the UE's PRACH attempts have failed for the required number of times, then the UE would apply the offset only for the neighbor cell to which the PRACH attempts have failed and not for its serving cell.

The EUTRAN re-selection criteria are very similar and a similar modification could be made to 3GPP TS36.304 to implement these teachings for cell re-selection, for both heterogeneous deployments and for stationary UEs.

Consider one implementation in which the condition is two-fold: the UE's PRACH attempts fail three consecutive times, and the cell broadcasts in system information the value for the temporary offset. This can be implemented for example with the following algorithm which may be set forth in a published radio specification so that all UEs follow it:

2>if V300 is greater than N300:
3>enter idle mode.
3>consider the procedure to be unsuccessful;
3>if UE repeatedly detects 3 times that V300 is greater than N300 in the same cell:
   4>apply Temp_offset as signalled in system information block type 11 to this cell when performing the cell selection and reselection until the UE has detected 2 cell selections or reselections according to [4].

In the above algorithm, V300 is the UE's running timer for awaiting a response to the PRACH that the UE sent uplink which initiates this timer, N300 is the maximum time the UE waits after which the UE concludes the attempt has failed if the UE has not received any response, 3 is the predetermined number (maximum number) of PRACH attempts to meet one of the conditions to apply the offset, and the UE has received the offset value in SIB type 11 which is the other condition to apply the offset.

The above algorithm also has a reset feature to remove the offset, which is implemented by the final clause until the UE has detected 2 cell selections or reselections. This is an example of an implementation of the second embodiment of the invention which is detailed hereinafter. This second embodiment may be implemented with the first embodiment or separately.

The solution proposed by documents R2-130436 and R2-130440 (see the background section above) is that the UE make a determination that a given cell is “not for use” for a fixed period of time during which that cell is barred from selection/re-selection by that UE. The second embodiment of this invention can for example be used with the cell-barring portion of that proposed solution. For this reason, rather than discuss this second embodiment in terms of the condition or conditions being met to apply the offset, it is more generally described with respect to the condition or conditions for applying the restriction being met where the “restriction” encompasses the offset as described above for the first embodiment as well as other kinds of restrictions such as barring a cell from evaluation for selection/re-selection for example.

According to this second embodiment of these teachings, after applying any restrictions due to the condition(s) being met (such as the RACH failure condition for example), the UE then counts its successful reselections and, once a threshold number of successful reselections is met, the UE removes any restrictions that were imposed due to meeting the condition(s) originally. This second embodiment ensures that any UE moving out of the problem area identified at FIG. 1 is not affected for longer than necessary, and only the stationary UEs will retain the restriction. Advantageously, user devices that are not only stationary but also non-mobile, such as many types of MTC devices, are the only ones which will retain the restriction indefinitely since non-mobile devices will be unable to meet the reset criterion that removes the restriction from its selection/re-selection evaluation.

This second embodiment also has utility beyond resolving only the specific Chiba issue. For example, in a heterogeneous network having macro and small cells, if the condition for applying a restriction is UE speed then a change in the UE speed would in short order naturally change the UE's number of re-selections over the specified time period, enabling the restriction to be removed when most appropriate for a give UE.

Consider for example that a UE has determined that some condition is satisfied for applying a restriction concerning cell selection/re-selection. The restriction can be barring the cell from further selection/re-selection evaluation, for example after 3 failed PRACH attempts. In this case the implementing algorithm can be as follows:

2>if V300 is greater than N300:
3>enter idle mode.
3>consider the procedure to be unsuccessful;
3>if UE repeatedly detects 3 times that V300 is greater than N300 in the same cell:
   4>consider the cell to be barred according to [4] and as using the value “allowed” in the IE “Intra frequency cell re-selection indicator”, until the UE has detected 2 cell selections or reselections according to [4].

The final clause of the above algorithm implements the second embodiment of these teachings on top of the cell-barring solution suggested by documents R2-130436 and R2-130440. To implement the first embodiment of these teachings also, the cell barring in the above algorithm can be changed to applying a temporary offset to the cell selection/re-selection criteria. And further according to the implementations for the first embodiment, the conditions under which that offset restriction is imposed can be one or more of: a) system information telling the UE this is a problem cell and to apply the offset, or b) the UE seeing from its UE type (such as the UE's subscription type or its device type or its device configuration) that it may have a problem with certain cells and will know to apply the offset, or c) from failing to succeed after some predetermined number of PRACH attempts, or d) the UE speed is below a speed threshold.

The second embodiment of this invention could also be used in circumstances other than resolving the Chiba issue. In general, any specific behaviour applied under a particular condition or set of conditions is reset upon detection of mobility over a certain threshold (for example, a threshold number of cell re-selections). This can be useful in scenarios in which a UE detects whether it is static or moving and applies specific mobility parameters for the case it finds that it is a stationary UE (such as most MTC devices are expected to be), yet applies the common parameters for the case it finds it is moving.

In another example mentioned above, a UE moving through different size cells in a heterogeneous network can use specific re-selection parameters when slow moving below some non-negligible threshold which is chosen to bias those UEs to the small cells, and, once the UE increases speed to exceed the threshold, the biasing mechanism is removed and so will not re-select to a small cell through which it will pass too quickly but rather stay on the larger macro cell.

The above first and second embodiments provide the technical effect of enabling different UE behaviour depending on whether the UE is stationary or moving. These embodiments also address the Chiba issue while limiting impact of the Chiba solution to other networks; some implementations can limit the effects of deploying them only to stationary devices within the Chiba area itself or similar lakeside type areas. A further technical effect is that certain embodiments of these teachings, such as where mobility is the condition, can be implemented quite easily in legacy systems like UTRAN and EUTRAN because they entail no additional signalling to implement. For those implementations where there is a signalling impact (system information), these offer an additional technical effect in that the network maintains positive control over when to implement the failure detection and associated actions. Even these implementations should be simple to adopt because the new signalling is only in system information rather than dedicated control signalling.

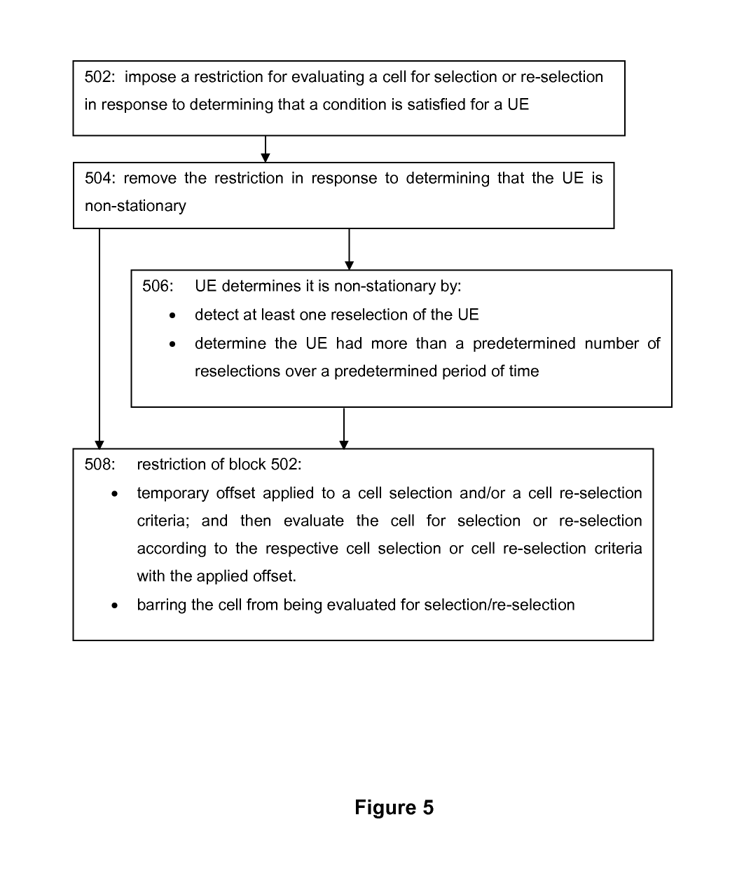

FIG. 4 presents a summary of the above teachings according to the first embodiment for operating a user equipment (UE) such as for example a UE operating in a UTRAN (including a WCDMA network), and in other deployments in a LTE and/or LTE-Advanced (LTE-A) network. As noted above, these are non-limiting deployments. At block 402 the UE applies a temporary offset to a cell selection and/or a cell re-selection criteria in response to determining that a condition is satisfied for the UE. Then at block 404 the UE evaluates the cell for selection or re-selection according to the respective cell selection or cell re-selection criteria with the applied offset, according to the first embodiment above.

Block 406 summarizes one non-limiting implementation of the second embodiment whereby the UE determines it is moving at a speed greater than the threshold speed as in block 404 by determining the UE has had more than a first predetermined number of reselections over a predetermined period of time.

Some of the non-limiting implementations for the first embodiment detailed above are also summarized at FIG. 4 following block 404.

Block 406 summarizes that the condition stated at block 402 can be a predetermined number of failed attempts to send a random access request to the cell (which in the above examples is the UE sending a preamble on the RACH), or the UE being of a specified type, or the UE speed being less than a threshold speed. In the case of UE speed as the condition, the examples above showed that the UE can determine its speed is less than the threshold speed by determining that it had fewer than a predetermined number of reselections over a predetermined period of time. Or for the case the UE gets a connection it can use handovers for this aspect, determining it had fewer handovers than the predetermined number. Block 406 further summarizes that the condition of block 402 can be that the UE received in system information from the cell an indication that the offset should be used for the cell, in which case the indication can be a flag or the value for the offset, or the indication can carry more information than just the value, such as the UE or subscription class to which the offset applies for example. In other embodiments the offset value can be in system information but it is only applied if some other condition or conditions are also satisfied.

In some implementations, satisfying the condition as stated at block 402 means satisfying two or more of the specific conditions summarized at block 406, or other conditions. The various embodiments and implementations of these teachings as summarized at FIG. 4 and above may be practiced by a UE that is a stationary machine-type communication MTC device for example.

Block 408 adds the optional reset feature to the FIG. 4 summary of the first embodiment, namely that the offset is removed in response to determining that a second condition is met. The non-limiting example above was that the UE had more than some minimum number of re-selections over a predetermined period of time, but in other embodiments it could be simply that the UE is not immobile/stationary in which case the UE can determine this by seeing that it had as few as one re-selection (even with no time constraint) More generically the UE can satisfy this second condition if the UE speed is greater than some predefined speed threshold, and that speed threshold can even be set to zero.

FIG. 5 presents a summary of the above teachings according to the second embodiment for operating a user equipment (UE) as noted above. At block 502 the UE imposes a restriction for evaluating a cell for selection or re-selection in response to determining that a condition is satisfied for itself. Then at block 504 the UE removes the restriction in response to determining that the UE is non-stationary.

Block 506 provides a few non-limiting examples of how the UE can determine it is non-stationary. In one implementation the UE can detect that it has undergone at least one reselection (or handover) to determine it is non-stationary. In another implementation the UE can count that it has had more than a predetermined number of reselections or handovers (whether over a predetermined period of time or with no time reference) to determine that it is non-stationary.

Block 508 adds specific non-limiting implementations for the restriction of block 502. In one implementation the restriction is the temporary offset from the first embodiment which is applied to a cell selection and/or a cell re-selection criteria. This is used by evaluating the cell for selection or re-selection according to the respective cell selection or cell re-selection criteria with the applied offset. In another implementation at block 508, the restriction is the UE barring the cell from being evaluated for selection and re-selection.

The processes represented at each of FIGS. 4 and 5 may be executed by the UE or by one or more components thereof, whenever it seeks to evaluate a cell for selection and/or re-selection or to remove/reset a restriction for evaluating cells for selection/re-selection. As non-limiting examples, such components may include a processor and a memory storing executable software code, or a universal system identity module (USIM), or a modem, or an antenna module, or a radiofrequency RF module (RF front end), or any combination of these.

The logic diagram of FIG. 4 and of FIG. 5 may each be considered to illustrate the operation of a method, and a result of execution of a computer program stored in a computer readable memory, and a specific manner in which components of an electronic device are configured to cause that electronic device to operate, whether such an electronic device is the UE or some other portable electronic device, or one or more components thereof such as a modem, chipset, or the like. The various blocks shown in FIG. 4 and separately in FIG. 5 may also be considered as a plurality of coupled logic circuit elements constructed to carry out the associated function(s), or specific result of strings of computer program code or instructions stored in a memory.

Such blocks and the functions they represent are non-limiting examples, and may be practiced in various components such as integrated circuit chips and modules, and the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Such circuit/circuitry embodiments include any of the following: (a) hardware-only circuit implementations (such as implementations in only analog and/or digital circuitry) and (b) combinations of circuits and software (and/or firmware), such as: (i) a combination of processor(s) or (ii) portions of processor(s)/software (including digital signal processor(s)), software, and memory(ies) that work together to cause an apparatus, such as a user equipment/UE, to perform the various functions summarized at FIG. 4 and (c) circuits, such as a microprocessor(s) or a portion of a microprocessor(s), that require software or firmware for operation, even if the software or firmware is not physically present. This definition of “circuitry” applies to all uses of this term in this specification, including in any claims. As a further example, as used in this specification, the term “circuitry” would also cover an implementation of merely a processor (or multiple processors) or portion of a processor and its (or their) accompanying software and/or firmware. The term “circuitry” also covers, for example, a baseband integrated circuit or application specific integrated circuit for a user equipment UE or a similar integrated circuit in another device that communicates wirelessly with a communications network having access nodes and higher network entities controlling them.

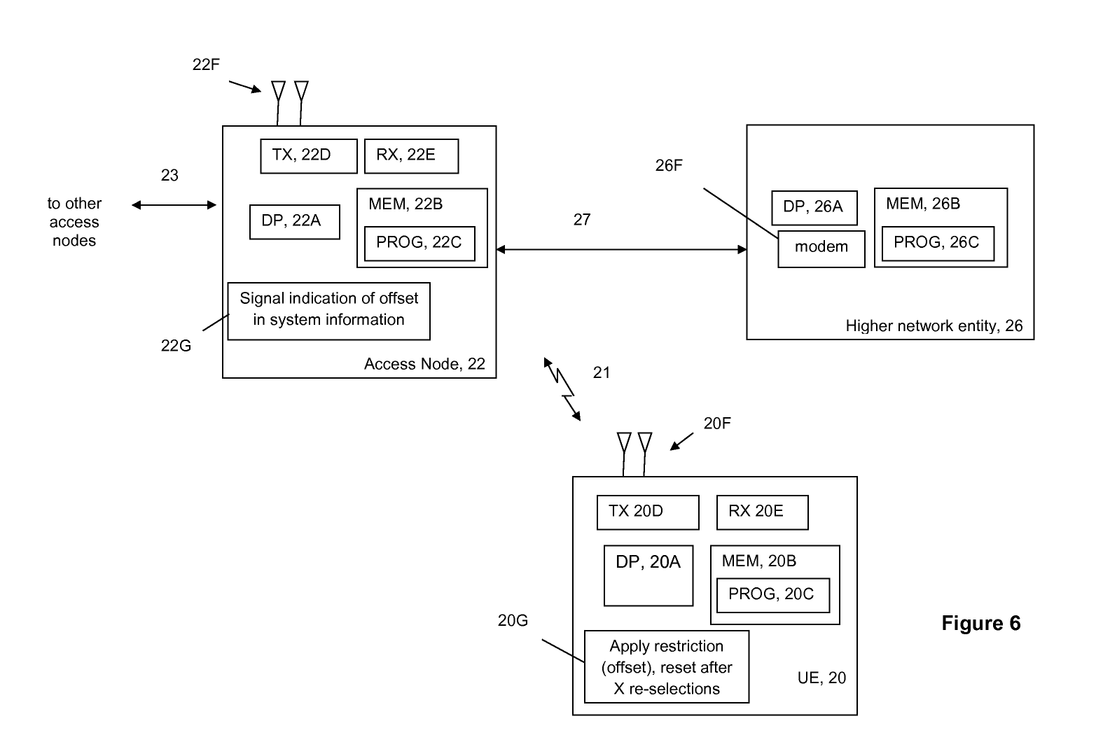

Reference is now made to FIG. 6 for illustrating a simplified block diagram of examples of various electronic devices and apparatus that are suitable for use in practicing the exemplary embodiments of this invention. In FIG. 6 a radio network access node 22 is adapted for communication over a wireless link 21 with an apparatus, such as a mobile terminal or UE 20. The access node 22 may be any access node such as a node B or an eNode B (including frequency selective repeaters and remote radio heads) of any wireless network, such as UTRAN, WCDMA, GSM, GERAN, E-UTRAN/LTE, and the like. The operator network of which the access node 22 is a part may also include a network control element such as a radio network controller RNC in the case of a UTRAN and WCDMA network. For the case of LTE/LTE-Advanced networks, the higher network entity represents a mobility management entity MME which may also serve as the serving gateway S-GW. This higher network entity 26 generally provides connectivity with the core cellular network and with further networks (e.g. a publicly switched telephone network PSTN and/or a data communications network/Internet).

The UE 20 includes processing means such as at least one data processor (DP) 20A, storing means such as at least one computer-readable memory (MEM) 20B storing at least one computer program (PROG) 20C, and first communication means such as a transmitter TX 20D and a receiver RX 20E for bidirectional wireless communications with the access node 22 using the operative radio access technology. All of the relevant wireless communications are via one or more antennas 20F. Also stored in the MEM 20B at reference number 20G are the computer code or algorithms for the UE to apply the restriction (which according to the first embodiment is the offset) and to reset/remove that restriction once the UE undergoes some predetermined number of re-selections after first imposing the restriction, according to exemplary embodiments above.

The access node 22 also includes processing means such as at least one data processor (DP) 22A, storing means such as at least one computer-readable memory (MEM) 22B storing at least one computer program (PROG) 22C, and communication means such as a transmitter TX 22D and a receiver RX 22E for bidirectional wireless communications with the UE 20 via one or more antennas 22F. The Access Node 22 stores at block 22G in certain embodiments its own computer software code or algorithms to include the indication of the offset in system information, such as for example in a new information element shown by example at FIG. 3. In some radio technologies the access node 22 will have a direct data/control link 23 with other adjacent access nodes.

Also at FIG. 6 is shown a higher network entity 26 above the radio access node 22. In LTE/LTE-Advanced this may be a mobility management entity or a serving gateway as noted above; in UTRAN and WCDMA it is a radio network controller. However implemented, the higher network entity 26 includes processing means such as at least one data processor (DP) 26A, storing means such as at least one computer-readable memory (MEM) 26B storing at least one computer program (PROG) 26C, and communication means such as a modem 26F for bidirectional communications with the access node 22 and with other access nodes under its control or coordination over the data and control link 27.

While not particularly illustrated for the UE 20 or the access node 22, those devices are also assumed to include as part of their wireless communicating means a modem and/or a chipset and/or an antenna chip which may or may not be inbuilt onto a radiofrequency (RF) front end module within those devices 20, 22 and which also operates according to the teachings set forth above.

At least one of the PROGs 20C in the UE 20 is assumed to include a set of program instructions that, when executed by the associated DP 20A, enable the device to operate in accordance with the exemplary embodiments of this invention, as detailed above and particularly summarized at FIGS. 4 and 5. The access node 22 also has software stored in its MEM 22B to implement certain aspects of these teachings, such as signalling the indication of the offset (whether via a flag or via the offset value) in system information. In these regards, the exemplary embodiments of this invention may be implemented at least in part by computer software stored on the MEM 20B, 22B which is executable by the DP 20A of the UE 20 and/or by the DP 22A of the access node 22; or by hardware, or by a combination of tangibly stored software and hardware (and tangibly stored firmware) in any one or more of these devices 20, 22. In this manner, the respective DP with the MEM and stored PROG may be considered a data processing system. Electronic devices implementing these aspects of the invention need not be the entire devices as depicted at FIG. 6 or may be one or more components of same such as the above described tangibly stored software, hardware, firmware and DP, or a system on a chip SOC or an application specific integrated circuit ASIC or a digital signal processor DSP or a modem or an antenna module or a RF front end module as noted above.

In general, the various embodiments of the UE 20 can include, but are not limited to personal portable digital devices having wireless communication capabilities, including but not limited to cellular and other mobile phones, navigation devices, laptop/palmtop/tablet computers, digital cameras and music devices, Internet appliances, USB dongles and data cards.

Various embodiments of the computer readable MEMs 20B, 22B, 26B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A, 26A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the UTRAN and WCDMA systems, as noted above the exemplary embodiments of this invention are not limited for use with only these particular types of wireless radio access technology networks.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for operating a user equipment, the method comprising:
applying a temporary offset to a cell selection and/or a cell re-selection criterion in response to determining that a condition is satisfied for a user equipment (UE); and thereafter:
evaluating the cell for selection or re-selection according to the respective cell selection or cell re-selection criterion with the applied offset.

2. The method according to claim 1, wherein the condition comprises a predetermined number of failed attempts to send a random access request to the cell.

3. The method according to claim 1, wherein the condition comprises the UE being of a specified type.

4. The method according to claim 1, wherein the condition comprises the UE speed being less than a threshold speed.

5. The method according to claim 4, wherein the UE determines its speed is less than the threshold speed by determining the UE had fewer than a predetermined number of reselections or handovers over a predetermined period of time.

6. The method according to claim 1, wherein the UE receives in system information broadcast by the cell an indication that the offset should be used for the cell.

7. (canceled)

8. The method according to claim 7, wherein the condition comprises the UE having received the indication in the system information.

9. (canceled)

10. (canceled)

11. The method according to claim 1, the method comprising:
removing the offset in response to determining that a second condition is met.

12. The method according to claim 11, wherein the second condition comprises UE speed exceeding a speed threshold or the UE being non-stationary.

13. An apparatus for operating a user equipment, the apparatus comprising a processing system that comprises at least one processor and at least memory storing a computer program, wherein the processing system is configured to cause the apparatus at least to:
apply a temporary offset to a cell selection and/or a cell re-selection criterion in response to determining that a condition is satisfied for a user equipment (UE); and thereafter:
evaluate the cell for selection or re-selection according to the respective cell selection or cell re-selection criterion with the applied offset.

14. The apparatus according to claim 13, wherein the condition comprises a predetermined number of failed attempts to send a random access request to the cell.

15. The apparatus according to claim 13, wherein the condition comprises the UE being of a specified type.

16. The apparatus according claim 13, wherein the condition comprises the UE speed being less than a threshold speed.

17. The apparatus according to claim 16, wherein the UE is configured to determine its speed is less than the threshold speed by determining the UE had fewer than a predetermined number of reselections or handovers over a predetermined period of time.

18. Apparatus according to claim 13, wherein the UE receives in system information broadcast by the cell an indication that the offset should be used for the cell.

19. (canceled)

20. Apparatus according to claim 18, wherein the condition comprises the UE having received the indication in the system information.

21. (canceled)

22. (canceled)

23. The apparatus according to claim 13, wherein the processing system is configured to cause the apparatus to:
remove the offset in response to determining that a second condition is met.

24. The apparatus according to claim 23, wherein the second condition comprises UE speed exceeding a speed threshold or the UE being non-stationary.

25. A computer readable memory tangibly storing a computer program, the computer program comprising a set of computer instructions for operating a user equipment, the set of computer instructions comprising:
code for applying a temporary offset to a cell selection and/or a cell re-selection criterion in response to determining that a condition is satisfied for a user equipment (UE); and
code for thereafter evaluating the cell for selection or re-selection according to the respective cell selection or cell re-selection criterion with the applied offset.

26. The computer readable memory according to claim 25, wherein the condition comprises a predetermined number of failed attempts to send a random access request to the cell.

27-53. (canceled)
